(19) United States
(12) Patent Application Publication
(10) Pub. No.: US 2024/0154126 A1
(43) Pub. Date: May 9, 2024

(54) SULFIDE-BASED BIPOLAR SOLID-STATE BATTERY ENABLED BY DRY PROCESS

(71) Applicant: GM Global Technology Operations LLC, Detroit, MI (US)

(72) Inventors: Yong LU, Shanghai (CN); Zhe Li, Shanghai (CN); Qili Su, Shanghai (CN); Haijing Liu, Shanghai (CN)

(21) Appl. No.: 18/361,968

(22) Filed: Jul. 31, 2023

(30) Foreign Application Priority Data
Nov. 8, 2022 (CN) 202211394693.8

(51) Int. Cl. H01M 4/62; H01M 4/04; H01M 4/139; H01M 10/0525; H01M 10/0562; H01M 10/0585

(52) U.S. Cl. CPC H01M 4/623; H01M 4/0435; H01M 4/139; H01M 4/625; H01M 10/0525; H01M 10/0562; H01M 10/0585; H01M 2004/029

(57) ABSTRACT

A bipolar battery cell includes a bipolar electrode including a bipolar current collector and a cathode electrode arranged on one side of the bipolar current collector. The cathode electrode includes cathode active material for exchanging lithium ions, a first solid electrolyte, and first polytetrafluoroethylene (PTFE) fibrils. An anode electrode is arranged on an opposite side of the bipolar current collector, wherein the anode electrode includes anode active material for exchanging lithium ions, a second solid electrolyte, and second PTFE fibrils.

### CROSS-REFERENCE TO RELATED APPLICATIONS

This application claims the benefit of Chinese Patent Application No. 202211394693.8, filed on Nov. 8, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells for electric vehicles or other applications.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased power density to increase the range of the EVs.

Lithium-ion battery (LIB) cells are currently used for high power density applications. All-solid-state battery (ASSB) cells have improved characteristics as compared to LIB cells in terms of abuse tolerance, power capability and/or working temperature range. High volume manufacturing of ASSB at a reasonable price is challenging.

### SUMMARY

A bipolar battery cell includes a bipolar electrode including a bipolar current collector and a cathode electrode arranged on one side of the bipolar current collector. The cathode electrode includes cathode active material for exchanging lithium ions, a first solid electrolyte, and first polytetrafluoroethylene (PTFE) fibrils. An anode electrode is arranged on an opposite side of the bipolar current collector, wherein the anode electrode includes anode active material for exchanging lithium ions, a second solid electrolyte, and second PTFE fibrils.

In other features, a solid electrolyte layer is arranged between a first one of the bipolar electrode and a second one of the bipolar electrode. The first solid electrolyte, the second solid electrolyte and the solid electrolyte layer include a solid electrolyte selected from a group consisting of pseudobinary sulfide, pseudoternary sulfide, and pseudoquaternary sulfide, a halide-based solid electrolyte, a hydride-based solid electrolyte, and combinations thereof.

In other features, the cathode active material is selected from a group consisting of rock salt layered oxides, spinel, polyanion cathode materials, surface-coated cathode materials and/or doped cathode materials. The anode active material is selected from a group consisting of carbonaceous material, silicon, silicon mixed with graphite, Li₄Ti₅O₁₂, transition-metals, and metal oxide/sulfide.

In other features, the first PTFE fibrils and the second PTFE fibrils have a particle size prior to pressing in a range from 300 μm to 800 μm. The cathode electrode includes a first solid electrolyte in a range from 0.1 to 30 wt %, the cathode active material in a range from 70 to 98 wt %, a first conductive additive in a range from 0.1 to 10 wt %, and the first PTFE fibrils in a range from 0.1 to 10 wt %. The anode electrode includes a second solid electrolyte in a range from 0.1 to 30 wt %, the anode active material in a range from 70 to 98 wt %, a second conductive additive in a range from 0.1 to 10 wt %, and the second PTFE fibrils in a range from 0.1 to 10 wt %.

In other features, the first PTFE fibrils are in a range from 0.1 to 3 wt %. The second PTFE fibrils are in a range from 0.1 to 3 wt %. The solid electrolyte layer includes solid electrolyte in a range from 90 to 99.9 wt % and third PTFE fibrils in a range from 0.1 to 10 wt %. The third PTFE fibrils are in a range from 0.1 to 5 wt %. The first conductive additive is selected from a group consisting of carbon black, graphite, graphene, graphene oxide, Super P, acetylene black, carbon nanofibers, and carbon nanotubes.

A method for making a bipolar battery cell includes manufacturing a bipolar electrode by forming a cathode electrode by pressing a dry cathode mixture including a first solid electrolyte, cathode active material, a first conductive additive, and first polytetrafluoroethylene (PTFE) particles more than two times without solvent to fibrillate the first PTFE particles, wherein fibrils of the first PTFE particles created by pre-mixing and press binding together the cathode mixture; forming an anode electrode by pressing a dry anode mixture including a second solid electrolyte, anode active material, a second conductive additive, and second PTFE particles more than two times without solvent to fibrillate the second PTFE particles, wherein fibrils of the second PTFE particles created by pre-mixing and press binding together the anode mixture; and laminating the cathode electrode and the anode electrode onto opposite sides of a bipolar current collector.

In other features, the method includes preparing a solid electrolyte layer using a dry process; arranging the solid electrolyte layer between a first one of the bipolar electrode and a second one of the bipolar electrode. The first solid electrolyte, the second solid electrolyte and the solid electrolyte layer include a solid electrolyte selected from a group consisting of pseudobinary sulfide, pseudoternary sulfide, pseudoquaternary sulfide, a halide-based solid electrolyte, a hydride-based solid electrolyte, and combinations thereof.

In other features, the cathode active material is selected from a group consisting of rock salt layered oxides, a spinel, a polyanion cathode material, a surface-coated cathode material, and a doped cathode material. The anode active material is selected from a group consisting of carbonaceous material, silicon, silicon mixed with graphite, Li₄Ti₅O₁₂, a transition-metal, and a metal oxide/sulfide.

In other features, the first PTFE particles and the second PTFE particles have a particle size prior to pressing in a range from 300 μm to 800 μm. The cathode mixture includes the first solid electrolyte in a range from 0.1 to 30 wt %, the cathode active material in a range from 70 to 98 wt %, the first conductive additive in a range from 0.1 to 10 wt %, and the first PTFE in a range from 0.1 to 10 wt %. The anode mixture includes the second solid electrolyte in a range from 0.1 to 30 wt %, the anode active material in a range from 70 to 98 wt %, the second conductive additive in a range from 0.1 to 10 wt %, and the second PTFE in a range from 0.1 to 10 wt %.

In other features, the first PTFE particles are in a range from 0.1 to 3 wt %. The second PTFE particles are in a range from 0.1 to 3 wt %. The solid electrolyte layer includes solid electrolyte in a range from 90 to 99.9 wt % and third PTFE particles in a range from 0.1 to 10 wt %. The third PTFE particles are in a range from 0.1 to 5 wt %. The first conductive additive is selected from a group consisting of carbon black, graphite, graphene, graphene oxide, Super P, acetylene black, carbon nanofibers, and carbon nanotubes.

In other features, forming the cathode electrode by pressing includes pressing the dry cathode mixture using three or more sets of rollers. The three or more sets of rollers operate at a temperature in a range from 80° C. to 200° C. At least two sets of the three or more sets of rollers operate at different linear rolling speeds in a range from 0.1 m/min to 5.0 m/min.

In other features, forming the cathode electrode by pressing includes pressing the dry cathode mixture using three or more sets of rollers. The three or more sets of rollers operate at a temperature in a range from 80° C. to 200° C. The three or more sets of rollers operate at the same linear rolling speed in a range from 0.1 m/min to 5.0 m/min.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a sulfide-based battery cell including an anode electrode, a cathode electrode, and current collectors according to the present disclosure;

FIG. 2 is a side cross-sectional view of an example of a bipolar sulfide-based battery cell including anode electrodes, cathode electrodes, and current collectors according to the present disclosure;

FIG. 3 is a side cross-sectional view of an example of a cathode electrode according to the present disclosure;

FIG. 4 is an enlarged view of an example of the cathode electrode according to the present disclosure measured by scanning electron microscope;

FIG. 5A illustrates an example of a method for manufacturing the anode electrode and cathode electrode on the current collector according to the present disclosure;

FIG. 5B is a side cross-sectional view of an example of the cathode electrode and the anode electrode arranged on the current collector according to the present disclosure;

FIG. 5C illustrates an example of a method for manufacturing the anode electrode and cathode electrode on the current collector according to the present disclosure;

FIG. 6A illustrates an example of a method for manufacturing the solid electrolyte according to the present disclosure;

FIG. 6B is a side cross-sectional view of an example of the solid electrolyte according to the present disclosure;

FIG. 6C illustrates an example of a method for manufacturing the solid electrolyte according to the present disclosure;

FIG. 7 is a graph illustrating an example of voltage as a function of state of charge for the battery cells according to the present disclosure; and

FIG. 8 is a graph illustrating an example of capacity retention and columbic efficiency as a function of cycle number for the battery cells according to the present disclosure.

In the drawings, reference numbers may be reused to identify similar and/or identical elements.

### DETAILED DESCRIPTION

While the battery cells according to the present disclosure are described below in the context of a vehicle, the battery cells according to the present disclosure can be used in other applications.

Large-format sulfide-based solid-state batteries (S-SSB) are typically manufactured using a wet-coating method, which is similar to a slurry process. In the wet coating process for a cathode electrode, a cathode mixture, binder, and solvent are processed to a slurry and then coated on a current collector such as aluminum foil. Similar approaches are used for the anode electrode and solid electrolyte layer.

However, the solvents that are used in the wet-coating method are limited to nonpolar or less polar solvents due to high reactivity of solid electrolytes with the solvent and compatibility between solvents and the binder. Using solvents during fabrication poses a high financial and ecological burden.

A bipolar sulfide-based solid-state battery (S-SSB) according to the present disclosure is manufactured using free-standing electrodes and a solid electrolyte layer. The bipolar S-SSB is manufactured using a dry process with a polytetrafluoroethylene (PTFE) binder. Through continuous shearing force in a dry condition, the PTFE is fibrillated. Fibrils of the PTFE adhere to electrode particles and hold them together to form a free-standing electrode film. Using this manufacturing approach eliminates the use of solvents. As a result, side reactions and compatibility issues related to solvents are eliminated. This approach also enables high mass loading of the electrodes.

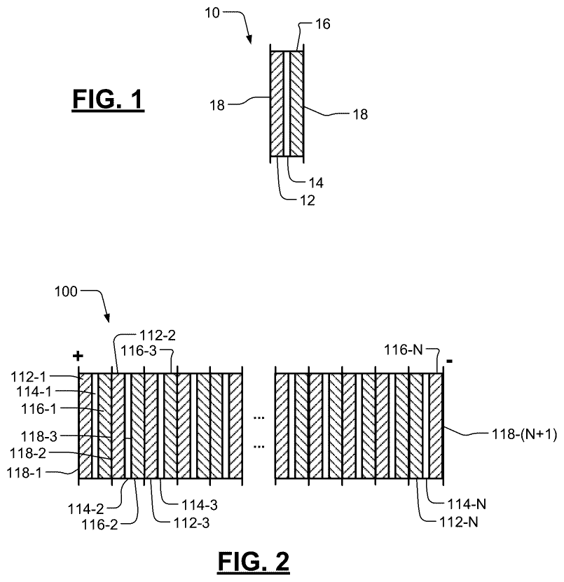

Referring now to FIG. 1, a battery cell 10 includes a cathode electrode 12 arranged adjacent to a solid electrolyte layer 14. In some examples, the solid electrolyte layer 14 is sulfide-based. An anode electrode 16 is arranged adjacent to the solid electrolyte layer 14. Current collectors 18 are arranged adjacent to the cathode electrode 12 and the anode electrode 16. As will be described further below, the cathode electrode 12, the anode electrode 16, and the solid electrolyte layer 14 are made using a dry process without the use of solvents. In some examples, the cathode electrode 12, the anode electrode 16, and the solid electrolyte layer 14 are made using PTFE binder.

In some examples, the cathode electrodes and the anode electrodes include solid electrolyte in a range from 0.1 to 30 wt %, electrode active materials in a range from 70 to 98 wt %, conductive additives in a range from 0.1 to 10 wt %, and PTFE binder in a range from 0.1 to 10 wt % (e.g., 0.1 to 3 wt %).

In some examples, the solid electrolyte layer includes solid electrolyte in a range from 90 to 99.9 wt % and PTFE binders in a range from 0.1 to 10 wt % (e.g., 0.1 to 5 wt %).

Referring now to FIG. 2, an example of a bipolar battery cell 100 including cathode electrodes 112-1, 112-2, . . . , and 112-N (collectively or individually cathode electrodes 112), solid electrolyte 114-1, 114-2, . . . , and 114-N (collectively or individually solid electrolyte 114), anode electrodes 116-1, 116-2, . . . , and 116-N (collectively or individually anode electrodes 116), and bipolar current collectors 118-1. 118-2, . . . , and 118-(N+1) (collectively or individually current collectors 118) is shown.

The cathode electrode 112-1 is arranged between the current collector 118-1 and the solid electrolyte 114-1. The anode electrode 116-1 is arranged between the solid electrolyte 114-1 and the current collector 118-2. The cathode electrode 114-2 is arranged between the current collector 118-2 and the solid electrolyte 114-2. The anode electrode 116-2 is arranged between the solid electrolyte 114-2 and the current collector 118-3. The other cathode electrodes 112, solid electrolyte 114, anode electrodes 116, and current collectors 118 are arranged in a similar manner. Positive and negative terminals of the bipolar battery cell 100 are connected to the current collectors 118-1 and 118-(N+1), respectively.

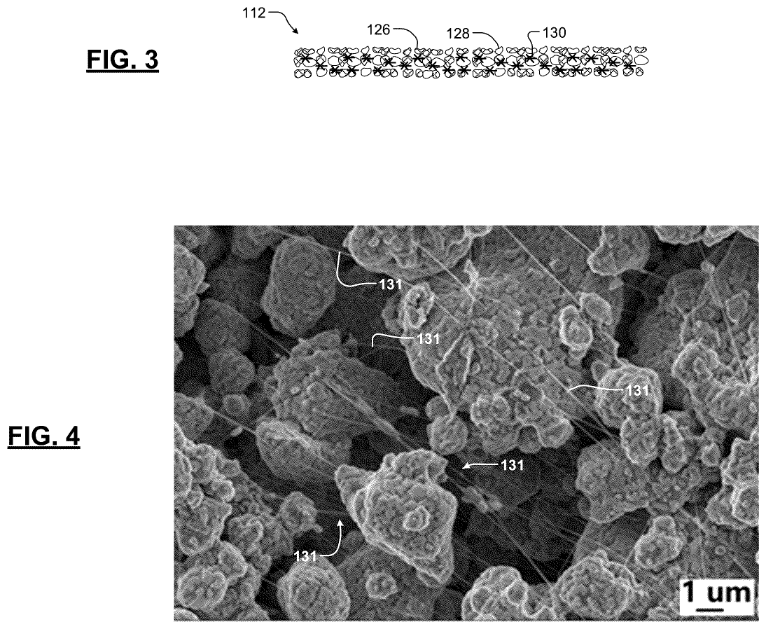

Referring now to FIGS. 3 and 4, additional details relating the composition of the cathode electrode 112 are shown. The cathode electrode 112 includes cathode active material 126, solid electrolyte 128, conductive additives (not shown) and a fibrillated binder 130. In FIG. 4, an enlarged view of the cathode electrode 112 measured by scanning electron microscope (SEM) is shown. Fibrils 131 of the fibrillated binder 130 help to hold the cathode electrode together.

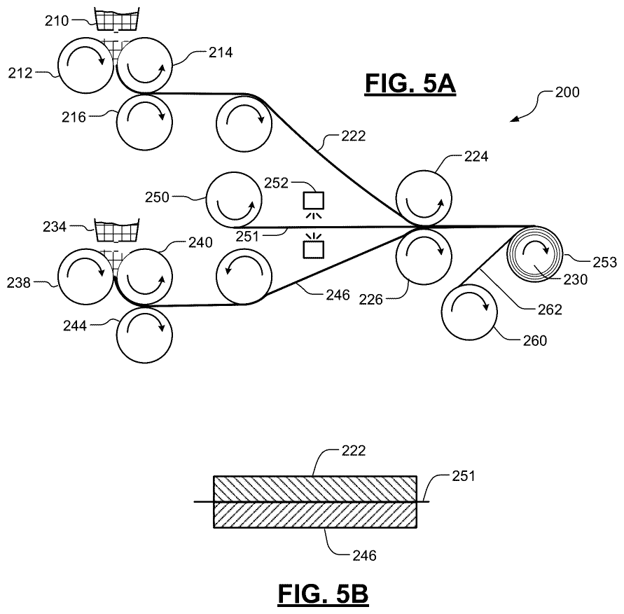

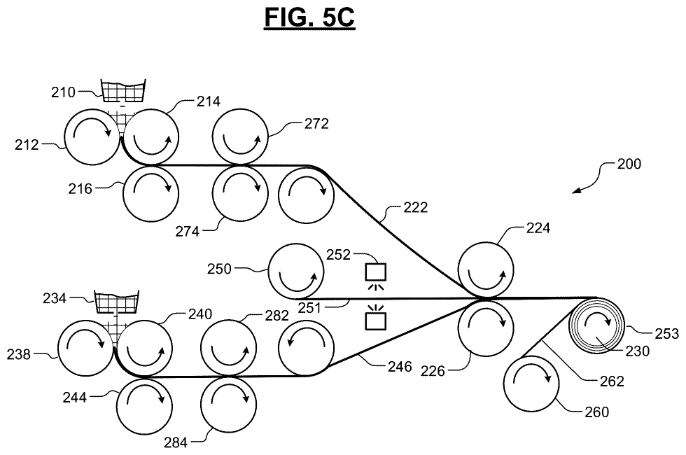

Referring now to FIGS. 5A to 5C, a method for manufacturing the anode electrode and cathode electrode on a bipolar current collector is shown. A first source 210 supplies a cathode mixture between rollers 212 and 214. The cathode mixture is further pressed between rollers 214 and 216 to create a cathode electrode 222 that is fed between rollers 224 and 226.

A second source 234 supplies an anode mixture between rollers 238 and 240. The anode mixture is further pressed between rollers 240 and 244 to create an anode electrode 246 that is fed between rollers 224 and 226. A roll 250 of current collector 251 is fed between the cathode electrode 222 and the anode electrode 246 and between rollers 224 and 226. In some examples, sprayers 252 coat opposite surfaces of the current collector 251 with conductive adhesive. The rollers 224 and 226 heat and/or press the cathode electrode 222, the current collector 251, and the anode electrode 246 into a laminate 253, which is fed onto a roll 230. A separating layer 262 such as PET is supplied by a roll 260 between the laminate 253 to prevent sticking or other interaction.

In FIG. 5B, the cathode electrode 222 and the anode electrode 246 are arranged on opposite sides of the current collector 251. In some examples, the rollers 214 and 216, 224 and 226, and 240 and 244 operate with high press density. In some examples, high press density refers to high density of the electrode layer after pressing, which is beneficial to the energy density. In some examples, high press density is in a range from 2.8 to 4.0 g/cm³.

In some examples, the rollers 212, 214 and 216 and 238, 240 and 244 operate at a temperature in a first predetermined range from 25° C. to 200° C. In some examples, the rollers 212, 214 and 216 and 238, 240 and 244 operate at a temperature in a first predetermined range from 120° C. to 200° C. In some examples, the rollers 224 and 226 operate at a temperature in a second predetermined range from 25° C. to 200° C. In some examples, the rollers 224 and 226 operate at a temperature in a second predetermined range from 80° C. to 200° C.

In some examples, the rollers 212, 214 and 216 and 238, 240 and 244 operate in two or more linear rolling speeds in a range from 0.1 m/min to 5.0 m/min. In some examples, the rollers 212, 214 and 216 and 238, 240 and 244 operate at the same linear rolling speed in a range from 0.1 m/min to 5.0 m/min.

In FIG. 5C, one or more pairs of additional rollers (e.g., 272 and 274, 282 and 284) can be used to gradually increase the cathode and anode press density to the target value.

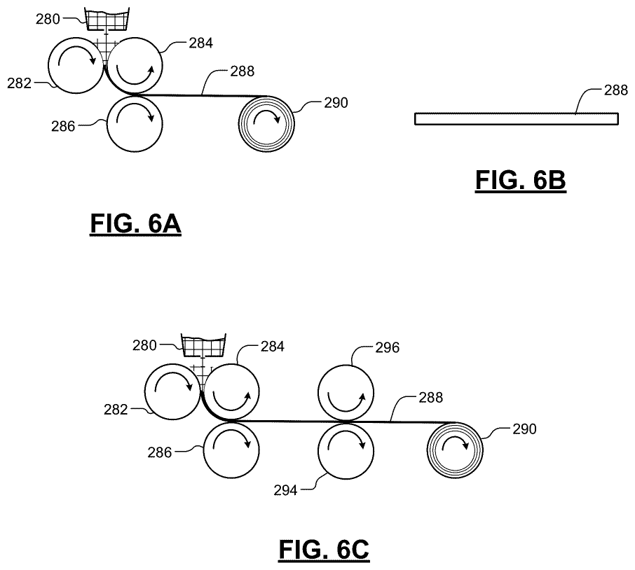

Referring now to FIGS. 6A to 6C, a method for manufacturing a solid electrolyte layer is shown. In FIGS. 6A and 6B, a source 280 supplies an electrolyte mixture between rollers 282 and 284 and 284 and 286 to create a solid electrolyte 288 that is wound around roll 290.

In FIG. 6C, one or more pairs of additional rollers 294 and 296 may be used to gradually decrease the solid electrolyte layer thickness to the target value ranging from 10 μm to 200 μm.

The laminates 253 and the solid electrolyte 288 are interleaved and then cut to create a battery cell. Alternately the laminates 253 and the solid electrolyte 288 are cut and then interleaved.

In some examples, the solid electrolyte is selected from a group consisting of pseudobinary sulfide, pseudoternary sulfide, and pseudoquaternary sulfide. Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, 0.4LiI·0.6Li₄SnS₄ and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

In other examples, the solid electrolyte is selected from a group consisting of halide or hydride solid electrolyte. Examples of halide-based solid electrolyte includes Li₃YCl₆, Li₃InCl₆, Li₃YBr₆, LiI, Li₂CdCl₄, Li₂MgCl₄, Li₂CdI₄, Li₂ZnI₄, Li₃OCl. Examples of hydride-based solid electrolyte include LiBH₄, LiBH₄—LiX (X=Cl, Br, or I), LiNH₂, Li₂NH, LiBH₄—LiNH₂, Li₃AlH₆. In other examples, other solid electrolyte with low grain-boundary resistance can be used.

In some examples, the cathode active material is selected from a group consisting of rock salt layered oxides, spinel, polyanion cathode materials, and surface-coated and/or doped cathode materials. Examples of rock salt layered oxides include LiCoO₂, LiNiₓMn_{y}Co_{1-x-y}O₂, LiNiₓMn_{y}Al_{1-x-y}O2, LiNiₓMn₁₋ₓO₂, and Li₁₊ₓMO₂. Examples of spinel include LiMn₂O₄, LiNi_{0.5}Mn_{1.5}O₄. Examples of polyanion cathode include LiV₂(PO₄)₃). In other examples, the cathode active material includes other lithium transition-metal oxides. Surface-coated and/or doped cathode materials such as LiNbO₃-coated LiMn₂O₄, Li₂ZrO₃ or Li₃PO₄-coated LiNiₓMn_{y}Co_{1-x-y}O₂, and Al-doped LiMn₂O₄. In other examples, low voltage cathode material such as lithiated metal oxide/sulfide (e.g., LiTiS₂), lithium sulfide, or sulfur can be used.

In some examples, the anode active material is selected from a group consisting of carbonaceous material (e.g., graphite, hard carbon, soft carbon etc.), silicon, silicon mixed with graphite, Li₄Ti₅O₁₂, transition-metals (e.g., Sn), metal oxide/sulfide (e.g., TiO₂, FeS and the likes), and other lithium-accepting anode materials. In some examples, the anode active material includes Li metal and a Li alloy.

In some examples, the conductive additive is selected from a group consisting of carbon black, graphite, graphene, graphene oxide, Super P, acetylene black, carbon nanofibers, carbon nanotubes and other electronically conductive additives.

In some examples, the binder includes PTFE and has a particle size in a range from 300 μm to 800 μm. In other examples, the PTFE has a particle size in a range from 400 μm to 700 μm.

In some examples, the current collectors (2˜30 um) include one or more materials selected from a group consisting of stainless steel, aluminum, nickel, iron, titanium, copper, tin (Sn), alloys, and combinations thereof. In some examples, a clad current collector including a laminate of aluminum and copper is used.

In some examples, the bipolar current collector surfaces include an electrically conductive adhesive layer. The electrically conductive adhesive layer includes polymer and an electrically conductive filler. In some examples, the electrically conductive filler is selected from a group consisting of carbon materials (e.g., Super P., carbon black, graphene, carbon nanotubes, carbon nanofibers) and metal powder.

In some examples, the polymer is selected to resist solvent and provide good adhesion. Examples of suitable polymer includes epoxy, polyimide (polyamic acid), polyester, vinyl ester; thermoplastic polymers (less solvent resistant) include PVDF, polyamide, silicone, and acrylic. In some examples, a mass ratio of filler/polymer is in a range from 0.1% to 50%. In some examples, single walled carbon nanotubes (SWCNT) and polyvinylidene difluoride (PVDF) with a mass ratio of SWCNT/PVDF equal to 0.2 is used.

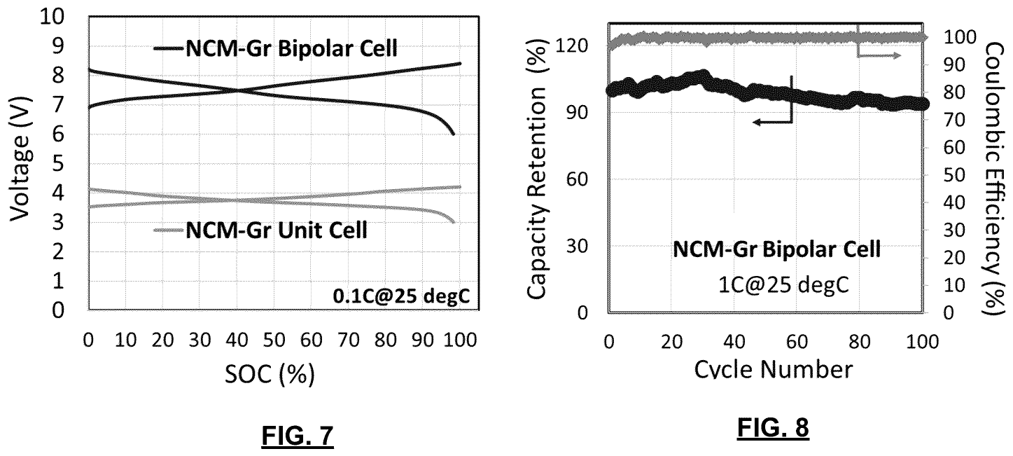

Referring now to FIGS. 7 and 8, improved performance of the sulfide-based bipolar battery cell is shown. In FIG. 7, voltage as a function of state of charge for the bipolar battery cell is shown relative to a control unit cell. In FIG. 8, a graph illustrates an example of capacity retention and columbic efficiency as a function of cycle number for the bipolar battery cell.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A bipolar battery cell, comprising:
a bipolar electrode comprising:
a bipolar current collector;
a cathode electrode arranged on one side of the bipolar current collector,
wherein the cathode electrode includes cathode active material for exchanging lithium ions, a first solid electrolyte, and first polytetrafluoroethylene (PTFE) fibrils; and
an anode electrode arranged on an opposite side of the bipolar current collector, wherein the anode electrode includes anode active material for exchanging lithium ions, a second solid electrolyte, and second PTFE fibrils.

2. The bipolar battery cell of claim 1, further comprising:
a solid electrolyte layer arranged between a first one of the bipolar electrode and a second one of the bipolar electrode,
wherein the first solid electrolyte, the second solid electrolyte and the solid electrolyte layer include a solid electrolyte selected from a group consisting of pseudobinary sulfide, pseudoternary sulfide, and pseudoquaternary sulfide, a halide-based solid electrolyte, a hydride-based solid electrolyte, and combinations thereof.

3. The bipolar battery cell of claim 1, wherein:
the cathode active material is selected from a group consisting of rock salt layered oxides, spinel, polyanion cathode materials, surface-coated cathode materials and/or doped cathode materials, and
the anode active material is selected from a group consisting of carbonaceous material, silicon, silicon mixed with graphite, Li₄Ti₅O₁₂, transition-metals, and metal oxide/sulfide.

4. The bipolar battery cell of claim 1, wherein the first PTFE fibrils and the second PTFE fibrils have a particle size prior to pressing in a range from 300 μm to 800 μm.

5. The bipolar battery cell of claim 1, wherein:
the cathode electrode includes a first solid electrolyte in a range from 0.1 to 30 wt %, the cathode active material in a range from 70 to 98 wt %, a first conductive additive in a range from 0.1 to 10 wt %, and the first PTFE fibrils in a range from 0.1 to 10 wt %, and
the anode electrode includes a second solid electrolyte in a range from 0.1 to 30 wt %, the anode active material in a range from 70 to 98 wt %, a second conductive additive in a range from 0.1 to 10 wt %, and the second PTFE fibrils in a range from 0.1 to 10 wt %.

6. The bipolar battery cell of claim 5, wherein:
the first PTFE fibrils are in a range from 0.1 to 3 wt %, and
the second PTFE fibrils are in a range from 0.1 to 3 wt %.

7. The bipolar battery cell of claim 2, wherein the solid electrolyte layer includes solid electrolyte in a range from 90 to 99.9 wt % and third PTFE fibrils in a range from 0.1 to 10 wt %.

8. The bipolar battery cell of claim 7, wherein the third PTFE fibrils are in a range from 0.1 to 5 wt %.

9. The bipolar battery cell of claim 5, wherein the first conductive additive is selected from a group consisting of carbon black, graphite, graphene, graphene oxide, Super P, acetylene black, carbon nanofibers, and carbon nanotubes.

10. A method for making a bipolar battery cell, comprising:
manufacturing a bipolar electrode by:
forming a cathode electrode by pressing a dry cathode mixture including a first solid electrolyte, cathode active material, a first conductive additive, and first polytetrafluoroethylene (PTFE) particles more than two times without solvent to fibrillate the first PTFE particles, wherein fibrils of the first PTFE particles are created by pre-mixing and press binding together the dry cathode mixture;
forming an anode electrode by pressing a dry anode mixture including a second solid electrolyte, anode active material, a second conductive additive, and second PTFE particles more than two times without solvent to fibrillate the second PTFE particles, wherein fibrils of the second PTFE particles created by pre-mixing and press binding together the dry anode mixture; and
laminating the cathode electrode and the anode electrode onto opposite sides of a bipolar current collector.

11. The method of claim 10, further comprising:
preparing a solid electrolyte layer using a dry process;
arranging the solid electrolyte layer between a first one of the bipolar electrode and a second one of the bipolar electrode,
wherein the first solid electrolyte, the second solid electrolyte and the solid electrolyte layer include a solid electrolyte selected from a group consisting of pseudobinary sulfide, pseudoternary sulfide, pseudoquaternary sulfide, a halide-based solid electrolyte, a hydride-based solid electrolyte, and combinations thereof.

12. The method of claim 10, wherein:
the cathode active material is selected from a group consisting of rock salt layered oxides, a spinel, a polyanion cathode material, a surface-coated cathode material, and a doped cathode material, and
the anode active material is selected from a group consisting of carbonaceous material, silicon, silicon mixed with graphite, Li₄Ti₅O₁₂, a transition-metal, and a metal oxide/sulfide.

13. The method of claim 10, wherein the first PTFE particles and the second PTFE particles have a particle size prior to pressing in a range from 300 μm to 800 μm.

14. The method of claim 10, wherein:
the dry cathode mixture includes the first solid electrolyte in a range from 0.1 to 30 wt %, the cathode active material in a range from 70 to 98 wt %, the first conductive additive in a range from 0.1 to 10 wt %, and the first PTFE in a range from 0.1 to 10 wt %, and
the dry anode mixture includes the second solid electrolyte in a range from 0.1 to 30 wt %, the anode active material in a range from 70 to 98 wt %, the second conductive additive in a range from 0.1 to 10 wt %, and the second PTFE in a range from 0.1 to 10 wt %.

15. The method of claim 14, wherein:
the first PTFE particles are in a range from 0.1 to 3 wt %, and
the second PTFE particles are in a range from 0.1 to 3 wt %.

16. The method of claim 11, wherein the solid electrolyte layer includes solid electrolyte in a range from 90 to 99.9 wt % and third PTFE particles in a range from 0.1 to 10 wt %.

17. The method of claim 16, wherein the third PTFE particles are in a range from 0.1 to 5 wt %.

18. The method of claim 14, wherein the first conductive additive is selected from a group consisting of carbon black, graphite, graphene, graphene oxide, Super P, acetylene black, carbon nanofibers, and carbon nanotubes.

19. The method of claim 10, wherein:
forming the cathode electrode by pressing includes pressing the dry cathode mixture using three or more sets of rollers,
the three or more sets of rollers operate at a temperature in a range from 80° C. to 200° C., and
at least two sets of the three or more sets of rollers operate at different linear rolling speeds in a range from 0.1 m/min to 5.0 m/min.

20. The method of claim 10, wherein:
forming the cathode electrode by pressing includes pressing the dry cathode mixture using three or more sets of rollers,
the three or more sets of rollers operate at a temperature in a range from 80° C. to 200° C., and
the three or more sets of rollers operate at the same linear rolling speed in a range from 0.1 m/min to 5.0 m/min.
